(19) United States
(12) Patent Application Publication
(10) Pub. No.: US 2016/0188362 A1
(43) Pub. Date: Jun. 30, 2016

(54) LIBRARY APPARATUS FOR REAL-TIME PROCESS, AND TRANSMITTING AND RECEIVING METHOD THEREOF

(71) Applicant: Konan Technology Inc., Seoul (KR)

(72) Inventor: Jeong Sun PARK, Yongin-si (KR)

(73) Assignee: Konan Technology Inc., Seoul (KR)

(21) Appl. No.: 14/984,258

(22) Filed: Dec. 30, 2015

(30) Foreign Application Priority Data
Dec. 30, 2014 (KR) 10-2014-0194268

(51) Int. Cl. G06F 9/46

(52) U.S. Cl. CPC G06F 9/466

(57) ABSTRACT

A library transmission method for a real-time process in a client, which includes extracting a next target address (NextTargetAddress) from workflow data, and transmitting data to an agent of a library apparatus that corresponds to a corresponding target address.

### CROSS-REFERENCE TO RELATED APPLICATION(S)

This application claims the benefit under 35 U.S.C. §119(a) of Korean Patent Application No. 10-2014-0194268, filed on Dec. 30, 2014, in the Korean Intellectual Property Office, the entire disclosure of which is incorporated herein by reference for all purposes.

### BACKGROUND

1. Field

The following description relates to a library system, and more particularly, to an apparatus and method for a real-time process between a plurality of library apparatuses.

2. Description of the Related Art

If it is assumed that a solution is developed, which collects and merges HD-class images, and after 3D rendering and various effects processing, processes a 3D operation in real time, as well as an operation of a hologram monitor terminal, there is no device existing that is capable of performing collection, merging, rendering, special effect processing, and displaying. The reason is that it is not possible for dozens of encoding boards, GPU cards, etc. to be installed in only one device.

Thus, various functions are required to be divided into various devices and then processed. To this end, data between devices is required to be shared. Here, a simple method of sharing data between devices is to process files in such a manner that writes the files at one device and reads the files at other devices. However, since it takes a large amount of time for disk I/O, such a method is proper to be applied to simple sharing, but not to a real-time process.

### SUMMARY

Provided is a library apparatus and method for a real-time process, which does not consume time in disk I/O.

In one general aspect, a transmitting method for a real-time process in a library apparatus includes: extracting a next target address (NextTargetAddress) from workflow data; and transmitting data to an agent of a library apparatus which corresponds to a corresponding target address.

In another general aspect, a transmitting method for a real-time process in a library apparatus includes: setting shared memory; registering a callback function; beginning an agent service, and waiting for data to be transmitted from a client of another library apparatus; in response to a reception of an access request from the client, accepting a session connection; generating a new thread, and receiving data transmitted from the client; and storing, by the agent, the data transmitted from the client, in the shared memory.

In another general aspect, a library apparatus for a real time process includes: an agent to in response to an access request from a client of another library apparatus, accept a session connection, receive data transmitted from the client, and store the data in shared memory; a client to extract a next target address (NextTargetAddress) from workflow data, and transmit data to an agent of a library apparatus which corresponds to a corresponding target address; a control server accessor to communicate with a control server which assigns a workflow configuration work; and a controller to transmit data, transmitted by the agent from another library apparatus, to another library apparatus through the client by performing the work assigned by the control server accessor.

Other features and aspects may be apparent from the following detailed description, the drawings, and the claims.

### BRIEF DESCRIPTION OF THE DRAWINGS

FIG. 1 is a diagram illustrating a transmission library system for a real-time process according to an exemplary embodiment.

FIG. 2 is a flowchart illustrating a transmitting method for a real-time process at a library apparatus according to an exemplary embodiment.

FIG. 3 is a flowchart illustrating a receiving method for a real-time process at a library apparatus according to an exemplary embodiment.)

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Terms used throughout this specification are defined in consideration of functions according to exemplary embodiments, and can be varied according to a purpose of a user or manager, or precedent and so on. Therefore, definitions of the terms should be made on the basis of the overall context.

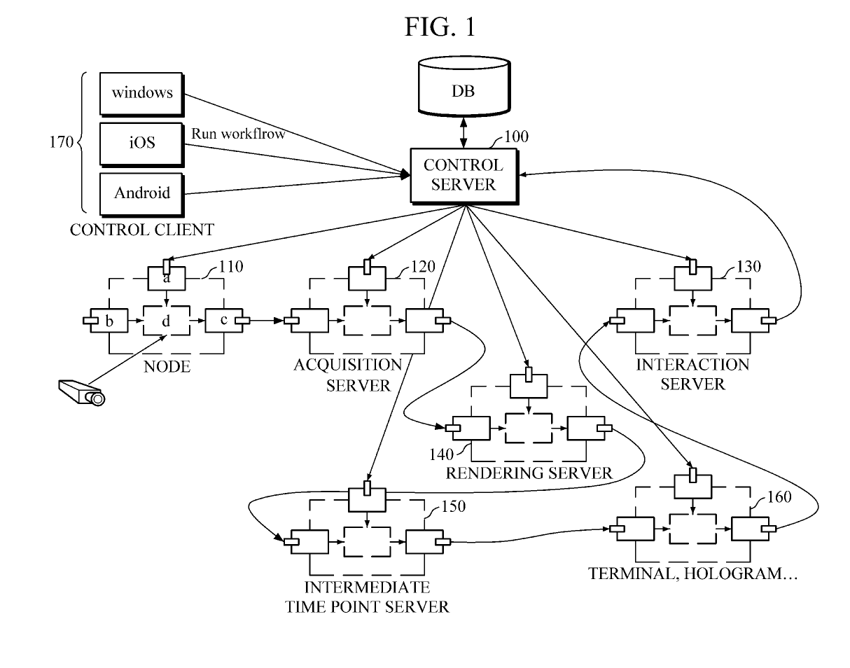

FIG. 1 is a diagram illustrating a transmission library system for a real-time process according to an exemplary embodiment.

Referring to FIG. 1, a transmission library system for a real-time process includes a plurality of several library apparatuses 110 to 160 and a control client 170, which access a control server 100 that manages a total system.

The control server 100 accesses one or a plurality of control clients 170 and operates the plurality of library apparatuses 110 to 160 in response to the instruction of the control client 170. An operating system, which overall controls the control client 170 in a network, may be Windows, iOS, or Android, which is available on the market.

The plurality of library apparatuses 110 to 160 each performs different functions in a certain workflow. For example, in a case of an image processing workflow as illustrated in FIG. 1, an acquisition server 120, an interaction server 130, a rendering server 140, an intermediate time point server 150, etc. may be included. The plurality of library apparatuses 110 to 160 may each have a control server accessor (a), an agent (b), a client (c), and a controller (d).

The control server accessor (a) communicates with a control server 100 and is assigned a workflow from the control server 100. The agent (b) receives a work instruction and an image stream from another library apparatus. The client (c) transmits the next instruction and an image stream to another library apparatus. The controller (d) operates an application, thereby performing functions which are assigned to itself by the control server 100 from the workflow the control client 170 has requested. For example, in a case of an image processing workflow, the rendering server 140 renders the data transmitted from the acquisition server 120. The present disclosure relates to a method of transmitting data memory to memory, not generating disk I/O between a plurality of library apparatuses 110 to 160. To this end, a client of one library apparatus transmits data to an agent of another library apparatus.

As receiving an access request from a client of another library apparatus, the agent (b) accepts a session connection, receives data transmitted from a client of another library apparatus, and stores the data in shared memory. The client (c) extracts the next target address (NextTargetAddress) from workflow data and transmits the data to an agent of a library apparatus that corresponds to the corresponding target address.

The controller (d) transmits the data, transmitted from another library apparatus by the agent (b), to yet another library apparatus through the client (c) by performing a work assigned by the control server accessor.

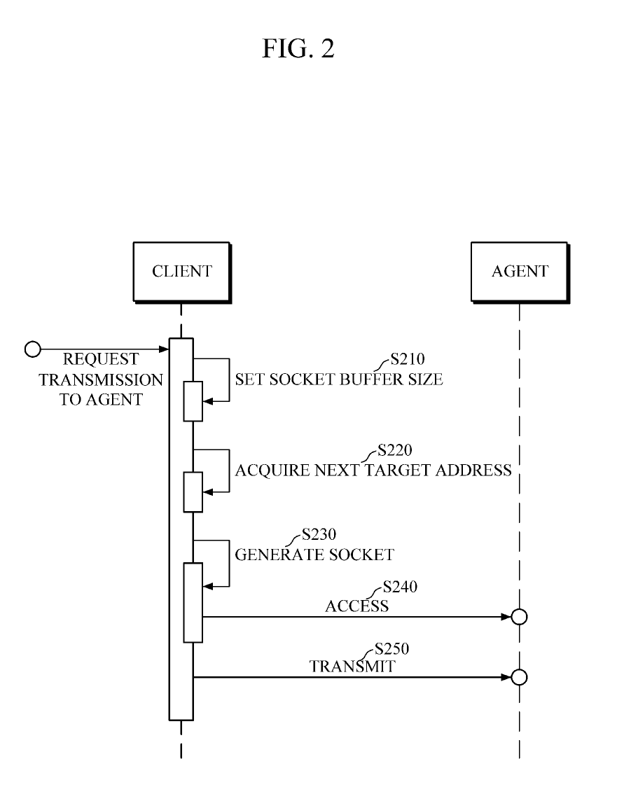

FIG. 2 is a flowchart illustrating a transmitting method for a real-time process at a library apparatus according to an exemplary embodiment. Here, a client and an agent are elements of each different library apparatus.

Referring to FIG. 2, as the client receives, from a controller, a request for a transmission to the agent, the client sets a socket buffer size, which is an amount of data to be transmitted at once to the agent of each different library apparatus in 210. Generally, the socket buffer size may be set to be 512 Kbyte to 3 Mbyte.

Then, the client extracts the next target address (NextTargetAddress) from workflow data in 220. For example, referring to FIG. 1, if the client is included in a rendering server 140, the NextTargetAddress may be an intermediate time point server 150. In addition, here, the NextTargetAddress may include TargetIP and TargetPort.

The client generates a socket related to the extracted, new target address in 230. Then, the client accesses an agent of a library apparatus corresponding to the extracted target address by using the generated socket in 240. Here, the client caches information on the generated socket, and in a case in which data transmission to the same address and port occurs, the client transmits the data by using the cached socket information so that a time taken for an access is reduced. Thus, FIG. 2 may further include an operation (not illustrated) of checking whether socket information corresponding to the extracted target address exists after operation 220, which in response to the existence of the target address, leads to operation 250, so that operations 230 and 240 are omitted.

The client transmits data to the agent accessed thereto in 250. Here, after the data transmission, the client does not receive an additional response message (Ack) so as to immediately transmit the next data. The agent also does not feedback an additional response message (Ack) and be ready for receiving the next data. The client is designed to, after operation 250, open the socket until the application ends, so as to recycle the accessed socket.

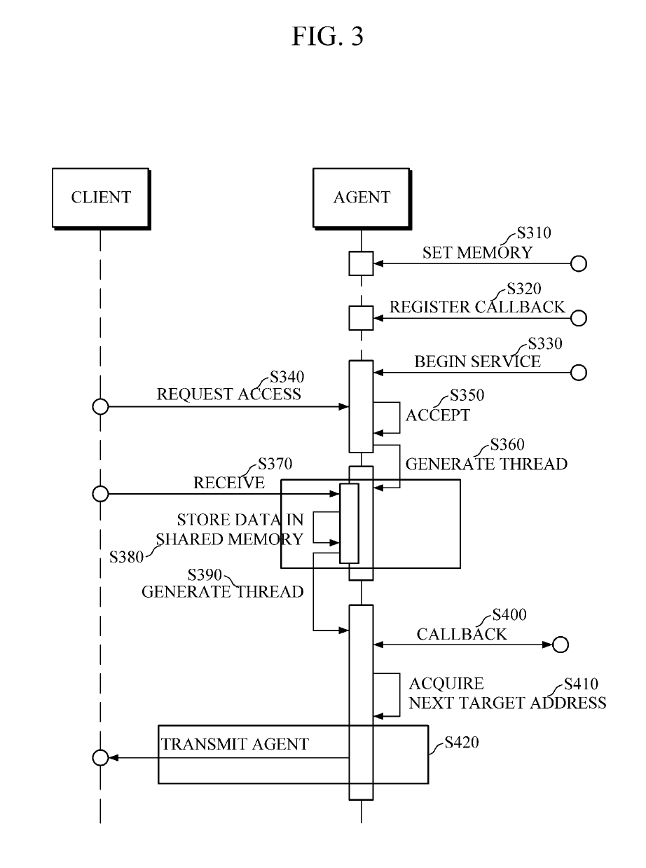

FIG. 3 is a flowchart illustrating a receiving method for a real-time process at a library apparatus according to an exemplary embodiment. Here, a client and an agent are elements of each different library apparatus.

Referring to FIG. 3, the agent sets shared memory in response to a request of a controller in 310, and more specifically, sets the shared memory in advance when initially running an application, so as to reduce time taken for memory assignment and deletion whenever the client transmits data. The agent writes data received from a client of a different library apparatus, and by using such a callback function, transmits an address of the shared memory to a controller that runs the application. Here, the callback is a work name to be written in a transmission flow definition of a client at the same library apparatus.

Thus, the agent registers a callback function for the corresponding work name in 320, and the client included in the same library apparatus calls a callback function that corresponds to the work name in a case in which the transmission flow definition and the data are transmitted.

Then, the agent begins an agent service and waits for data to be transmitted from a client is of another library apparatus in 330. As receiving an access request from the client in 340, the agent accepts a session connection in 350. Then, the agent generates a new thread in 360 and receives the data transmitted by the client in 370. Here, the reason why the thread is used is to immediately process an access request from another client.

The agent stores the data transmitted from the client in an acquired memory in 380. If the agent receives all the data, the agent generates the thread in 390 and calls a callback in the thread in 400, so that the agent immediately receives the next data from the client. In a case in which the callback function returns, the agent searches for target information to be transmitted next, and if the target information exists, the agent transmits the target information to the next agent through a client function in 410 and 420.

The present disclosure, a library apparatus for a real-time process and a transmitting and receiving method thereof, may transmit data to a network by using a memory-to-memory manner between devices which minimize memory copies, not generating disk I/O.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transmitting method for a real-time process in a library apparatus, comprising:
extracting a next target address (NextTargetAddress) from workflow data; and
transmitting data to an agent of a library apparatus which corresponds to a corresponding target address.

2. The transmitting method of claim 1, further comprising:
prior to the extracting of the next target address, setting a socket buffer size (SocketBuffer Size), which is an amount of data to be transmitted at once to the agent.

3. The transmitting method of claim 1, further comprising:
checking whether socket information corresponding to the extracted target address exists; and
in response to no existence of the extracted target address, generating a socket and setting an access for the generated socket.

4. A transmitting method for a real-time process in a library apparatus, comprising:
setting shared memory;
registering a callback function;
beginning an agent service, and waiting for data to be transmitted from a client of another library apparatus;
in response to a reception of an access request from the client, accepting a session connection;
generating a new thread, and receiving data transmitted from the client; and
storing, by the agent, the data transmitted from the client, in the shared memory.

5. A library apparatus for a real time process, comprising:
an agent configured to in response to an access request from a client of another library apparatus, accept a session connection, receive data transmitted from the client, and store the data in shared memory;
a client configured to extract a next target address (NextTargetAddress) from workflow data, and transmit data to an agent of a library apparatus which corresponds to a corresponding target address;
is a control server accessor configured to communicate with a control server which assigns a workflow configuration work; and
a controller configured to transmit data, transmitted by the agent from another library apparatus, to another library apparatus through the client by performing the work assigned by the control server accessor.

6. The library apparatus of claim 5, wherein the client is configured to check whether socket information corresponding to the extracted target address exists, and in response to no existence of the extracted target address, generate a socket and set an access for the generated socket.
